(19) United States
(12) Patent Application Publication
(10) Pub. No.: US 2022/0128930 A1
(43) Pub. Date: Apr. 28, 2022

(54) POWDER SUPPLYING DEVICE

(71) Applicant: SEIKO EPSON CORPORATION, Tokyo (JP)

(72) Inventors: Taiki KONO, Ina (JP); Shogo NAKADA, Matsumoto (JP)

(21) Appl. No.: 17/506,729

(22) Filed: Oct. 21, 2021

(30) Foreign Application Priority Data
Oct. 23, 2020 (JP) 2020-178018

(51) Int. Cl. G03G 15/08

(52) U.S. Cl. CPC G03G 15/0822

(57) ABSTRACT

A powder supplying device includes: a storage section including a storage container that includes an interior space in which a powder is stored and a discharge port through which the powder is discharged from the interior space to the exterior; a roller an outer peripheral surface of which is rough and which is provided across the interior space and the exterior and configured to rotate in the discharge port; and a powder-discharging-amount adjusting section that includes a pressing member which is formed of an elastic porous body and which is pressed against the outer peripheral surface of the roller.

The present application is based on, and claims priority from JP Application Serial Number 2020-178018, filed Oct. 23, 2020, the disclosure of which is hereby incorporated by reference herein in its entirety.

### BACKGROUND

### 1. Technical Field

The present disclosure relates to a powder supplying device.

### 2. Related Art

Powder scattering devices that scatter and supply powder to a target have been known. For example, a powder scattering device described in JP-A-2012-228639 includes a powder storage container that stores powder, a scattering roller provided in the powder storage container, and a doctor blade that is pressed against the scattering roller. The scattering roller has a surface including irregularities. Upon rotation of the scattering roller, the powder attached to the irregularities is discharged from the powder storage container, scraped by the doctor blade, and drops. Accordingly, the powder is supplied to the target located below the powder storage container.

However, when a portion of the doctor blade, which is pressed against the scattering roller, is formed of a rigid body, it is difficult to quantitatively supply the powder depending on conditions of the powder. Further, an increase in resistance to the scattering roller may prevent the rotation. On the other hand, when the portion of the doctor blade, which is pressed against the scattering roller, is formed of a soft material, it is difficult to excellently scrape the powder attached to the scattering roller, resulting in difficulty in quantitative supply of the powder. As described above, a material of the portion of the doctor blade, which is pressed against the scattering roller, has not been sufficiently considered.

### SUMMARY

The disclosure is made to address the aforementioned problem and is able to be implemented as follows.

A powder supplying device of the disclosure includes: a storage section including a storage container that includes an interior space in which a powder is stored and a discharge port through which the powder is discharged from the interior space to an exterior; a roller an outer peripheral surface of which is rough and which is provided across the interior space and the exterior and configured to rotate in the discharge port; and a powder-discharging-amount adjusting section that includes a pressing member which is formed of an elastic porous body and which is pressed against the outer peripheral surface of the roller.

### BRIEF DESCRIPTION OF THE DRAWINGS

FIG. 1 is a sectional view of a powder supplying device of the disclosure.

FIG. 2 is an exploded perspective view illustrating an example of a roller illustrated in FIG. 1.

FIG. 3 is an enlarged view illustrating an example of a portion of the roller illustrated in FIG. 1.

FIG. 4 is a sectional view of a pressing member of the powder supplying device illustrated in FIG. 1.

### DESCRIPTION OF EXEMPLARY EMBODIMENTS

Hereinafter, a powder supplying device of the disclosure will be described in detail with reference to a suitable embodiment illustrated in the accompanying drawings.

### Embodiment

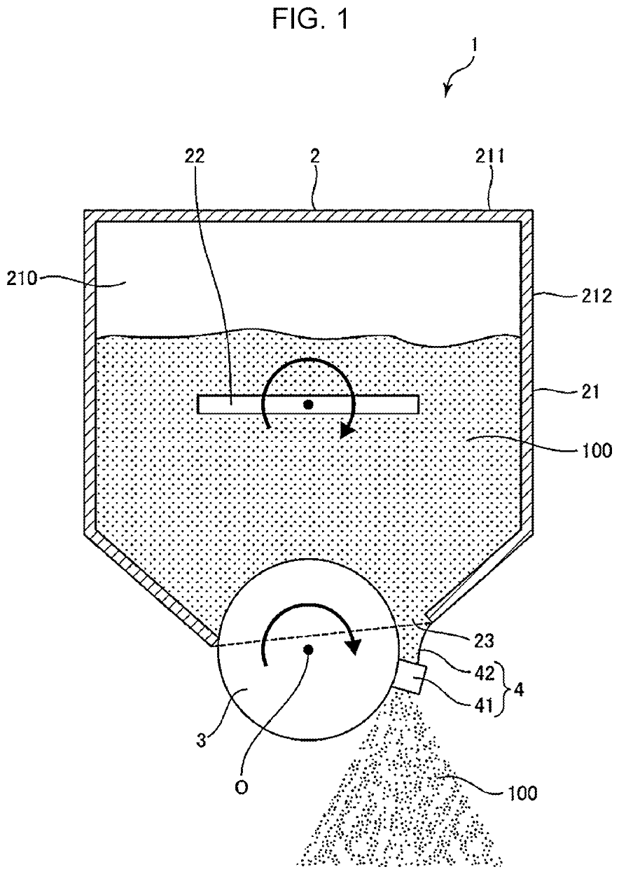

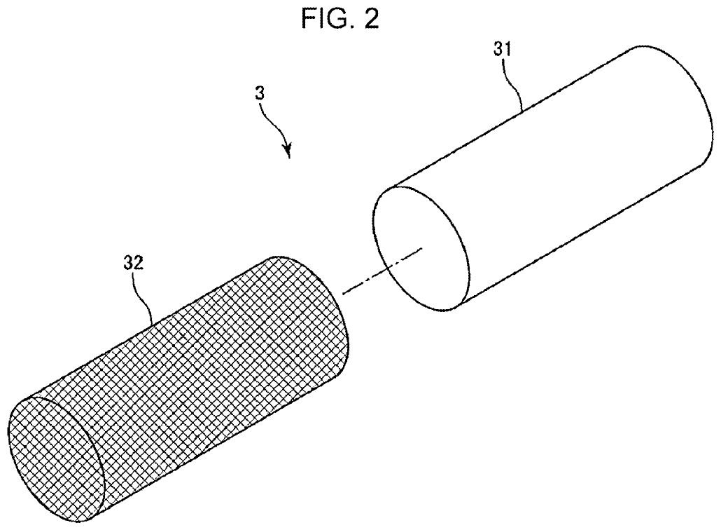

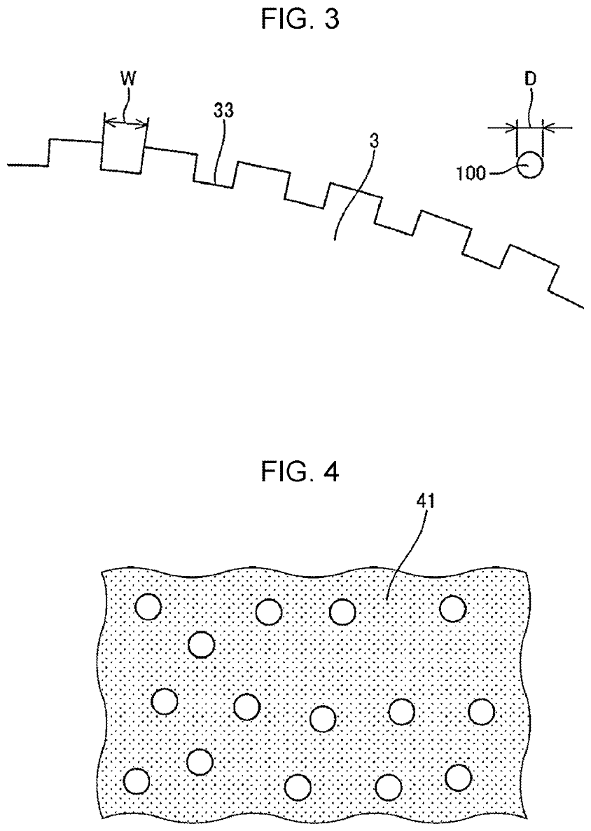

FIG. 1 is a sectional view of the powder supplying device of the disclosure. FIG. 2 is an exploded perspective view illustrating an example of a roller illustrated in FIG. 1. FIG. 3 is an enlarged view illustrating an example of a portion of the roller illustrated in FIG. 1. FIG. 4 is a sectional view of a pressing member of the powder supplying device illustrated in FIG. 1.

Note that, in the following description, for convenience of description, an upper side in FIG. 1 is referred to as “above” or “up”, and a lower side therein is referred to as “below” or “down”. Note that, in the drawing, the upper side is the vertically up direction, and the lower side is the vertically down direction.

As illustrated in FIG. 1, a powder supplying device 1 includes a storage section 2 that stores powder 100, a roller 3, and a powder-discharging-amount adjusting section 4. The powder supplying device 1 scatters and supplies the powder 100 to a target located below the roller 3. The powder supplying device 1 is usable as, for example, a device for scattering a release agent to be supplied to a space between sheets at a time of winding or layering a sheet, a device for supplying an antibacterial agent, a deodorizing agent, or the like, or a device for processing food.

The target is not particularly limited, and examples thereof include a sheet, which is formed of various kinds of resin materials, various kinds of rubbers, or various kinds of metal materials, and a sheet, which contains petroleum-based fibers or natural fibers.

As illustrated in FIG. 1, the storage section 2 includes a storage container 21 and a stirring section 22 that rotates in the storage container 21. The storage container 21 includes a discharge port 23 formed as an opening in the vertically down direction.

The storage container 21 includes a top plate 211 and a side wall 212 of a tubular shape. A space demarcated by the top plate 211 and the side wall 212 is an interior space 210. The side wall 212 has a quadrangular tube shape in the present embodiment. However, the side wall 212 is not limited to having such a configuration and may have, for example, a circular tube shape, a triangular tube shape, or a polygonal tube shape. In the present embodiment, the top plate 211 is provided so as to be openable/closable upon sliding, and the top plate 211 in the open state enables the powder 100 to be taken in or taken out.

A left-side lower portion and a right-side lower portion of the side wall 212 in FIG. 1 are inclined such that a separation distance therebetween decreases toward the lower side. The opening below the inclined portions is the discharge port 23.

The powder 100 is selected as appropriate depending on a purpose, and examples thereof include a resin material, an inorganic material, a metal material, and a natural material. One selected from these or a combination of two or more may be used.

The resin material is not particularly limited, and examples thereof include: polyolefin, such as AS resin, ABS resin, polyethylene, polypropylene, and an ethylene-vinyl acetate copolymer; modified polyolefin; acrylic resin, such as polymethyl methacrylate; polyvinyl chloride; polystyrene; polyester, such as polyethylene terephthalate and polybutylene terephthalate; polyamide, such as nylon 6, nylon 46, nylon 66, nylon 610, nylon 612, nylon 11, nylon 12, nylon 6-12, and nylon 6-66; polyphenylene ether; polyacetal; polyether; polyphenylene oxide; polyether-ether-ketone; polycarbonate; polyphenylene sulfide; thermoplastic polyimide; polyetherimide; a liquid crystal polymer, such as aromatic polyester; and various kinds of thermoplastic elastomers, such as styrene-based thermoplastic elastomer, polyolefin-based thermoplastic elastomer, polyvinyl chloride-based thermoplastic elastomer, polyurethane-based thermoplastic elastomer, polyester-based thermoplastic elastomer, polyamide-based thermoplastic elastomer, polybutadiene-based thermoplastic elastomer, trans polyisoprene-based thermoplastic elastomer, fluororubber-based thermoplastic elastomer, chlorinated polyethylene-based thermoplastic elastomer, and a polymer having an acid group on a side chain thereof. One selected from these or a combination of two or more kinds of materials selected from these may be used.

The inorganic material is not particularly limited, and examples thereof include: silica, such as crystalline silica, amorphous silica, and fused silica; aluminum hydroxide; magnesium hydroxide; calcium carbonate; magnesium carbonate; calcium silicate; magnesium silicate; calcium oxide; magnesium oxide; zinc oxide; alumina; aluminum nitride; aluminum borate whisker; boron nitride; antimony oxide; E-glass; D-glass; S-glass; and zeolite.

The metal material is not particularly limited, and examples thereof include vairous kinds of metal, such as nickel, iron, aluminum, tin, lead, chrome, cobalt, gold, and silver, a metal alloy, metal oxide, carbon, and graphite.

The natural material is not particularly limited, and examples thereof include starch, cellulose, cotton, linter, kapok, flax, hemp, ramie, and silk.

An average particle diameter D (refer to FIG. 3) of the powder 100 is not particularly limited and is desirably 1 μm or more and 1000 μm or less, more desirably, 150 μm or more and 800 μm or less, and still more desirably, 300 μm or more and 500 μm or less. Accordingly, it is possible to ensure quantitativeness more stably by the configuration of the powder supplying device 1 of the disclosure.

Note that, as the average particle diameter of the powder 100, for example, a mean volume diameter (MVD), which is a volume average particle size, measured by a laser-diffraction particle size distribution measuring device is able to be used. A particle size distribution measuring device which uses a laser diffraction/scattering method as the measurement principle, that is, a laser-diffraction particle size distribution measuring device, is able to measure a particle size on a volume basis.

Note that the shape of the powder 100 is not particularly limited and may be any shape, such as a spherical shape, a scale-like shape, and a needle-like shape.

An opening surface of the discharge port 23 has a rectangular shape in plan view. Note that, as indicated by the broken line in FIG. 1, the opening surface refers to a surface including the lower end of the side wall 212.

The stirring section 22 is an elongated plate-like member. The stirring section 22 is arranged above the roller 3 in the interior space 210. Moreover, the stirring section 22 is provided apart from the roller 3. The stirring section 22 rotates about the central axis thereof to stir the powder 100 in the interior space 210. This makes it possible to prevent or inhibit aggregations of the powder 100 from being generated and further promote feeding of the powder 100 toward the vicinity of the roller 3. As a result, it is possible to stabilize the amount of the powder 100 discharged from the discharge port 23.

The rotational direction of the stirring section 22 is not particularly limited and is desirably the same as the rotational direction of the roller 3. Accordingly, a flow of the powder 100, which is generated in the vicinity of the roller 3, and a flow of the powder 100, which is generated in the vicinity of the stirring section 22, collide with each other, making it possible to stir the powder 100 more effectively.

The roller 3 is provided across the interior and the exterior of the storage container 21 so as to close the discharge port 23. That is, a portion of the roller 3 is located in the interior space 210, and the remaining portion of the roller 3 is located outside the interior space 210, that is, below the storage container 21. The roller 3 is a column-shaped member that rotates about the central axis O. In the present embodiment, the roller 3 rotates clockwise.

The roller 3 is coupled to a motor (not illustrated), and when the motor is energized, a rotational force output from the motor is transferred to the roller 3, and the roller 3 rotates. Note that the configuration may be such that the rotational direction or the rotational speed of the roller 3 is adjusted by changing a condition for energizing the motor.

The outer peripheral surface of the roller 3 is rough. Accordingly, some powder 100 in the interior space 210 enters fine irregularities of the surface of the roller 3, and other powder 100 is attached to the powder 100 which has entered. As a result, aggregations of the powder 100 are attached to the surface of the roller 3. When the roller 3 rotates, the powder 100 attached to the surface of the roller 3 is transferred outside from the interior space 210, scraped by the powder-discharging-amount adjusting section 4 described later, and drops.

Surface roughness Rz of the outer peripheral surface of the roller 3, which is measured in accordance with JIS B 0601, is desirably 1 or more and 1000 or less, more desirably 100 or more and 900 or less, and still more desirably 150 or more and 750 or less.

When the surface roughness Rz of the outer peripheral surface of the roller 3 is within the aforementioned numerical ranges, particles having a relatively large particle diameter, for example, particles having a particle diameter of 300 μm or more, are able to be stored between the irregularities of the rough surface, and the powder 100 is able to be scattered more effectively in a quantitative manner.

When the surface roughness Rz is too small, it is difficult to quantitatively scatter the powder 100 having a relatively large particle diameter. On the other hand, when the surface roughness Rz is too large, it is difficult to quantitatively scatter the powder 100 having a relatively small particle diameter.

Specifically, when the average particle diameter D of the powder 100 is 100 μm or more and less than 300 μm, the surface roughness Rz of the outer peripheral surface of the roller 3 is desirably 10 or more and 700 or less. Accordingly, when the average particle diameter D of the powder 100 is within the numerical ranges as described above, it is possible to obtain the effect of the disclosure more reliably.

Moreover, when the average particle diameter D of the powder 100 is 300 μm or more and less than 500 μm, the surface roughness Rz of the outer peripheral surface of the roller 3 is desirably 30 or more and 900 or less. Accordingly, when the average particle diameter D of the powder 100 is within the numerical ranges as described above, it is possible to obtain the effect of the disclosure more reliably.

Furthermore, when the average particle diameter D of the powder 100 is 500 μm or more and less than 800 μm, the surface roughness Rz of the outer peripheral surface of the roller 3 is desirably 50 or more and 1200 or less. Accordingly, when the average particle diameter D of the powder 100 is within the numerical ranges as described above, it is possible to obtain the effect of the disclosure more reliably.

The rotational speed of the roller 3 is not particularly limited and is desirably 1 rpm or more and 600 rpm or less and more desirably 5 rpm or more and 300 rpm or less. Accordingly, it is possible to scatter the powder 100 more effectively in a quantitative manner while ensuring a sufficient discharging amount.

A ratio Rz/D of the surface roughness Rz of the outer peripheral surface of the roller 3 to the average particle diameter D of the powder 100 is desirably 0.05 or more and 1000 or less and more desirably 0.1 or more and 100 or less. Accordingly, it is possible to scatter the powder 100 more effectively in a quantitative manner while ensuring a sufficient discharging amount.

The outer diameter of the roller 3 is not particularly limited and is desirably 30 mm or more and 1000 mm or less and more desirably 50 mm or more and 800 mm or less, for example.

A constituent material of such a roller 3 is not particularly limited, and examples thereof include various kinds of hard metallic materials and various kinds of hard resin materials.

Moreover, the roller 3 may have the configuration illustrated in FIG. 2 or the configuration illustrated in FIG. 3, for example. In the configuration illustrated in FIG. 2, the roller 3 includes a core section 31 and a net-like cylinder 32 into which the core section 31 is inserted. The core section 31 has a column shape. The net-like cylinder 32 is a cylindrical mesh member.

The net-like cylinder 32 may be configured as a linear body knitted in a net shape or one including numerous through holes like so-called perforated metal.

In the case of such a configuration, the surface roughness Rz is able to have an appropriate value by setting a wire diameter, an aperture size, an opening ratio, or the like of the mesh as appropriate. Moreover, when a plurality of net-like cylinders 32 having different mesh sizes are prepared for replacement, the surface roughness Rz is able to be easily adjusted.

In the configuration illustrated in FIG. 3, a plurality of grooves 33 extending in the longitudinal direction of the roller 3 are formed. The grooves 33 are each arranged in the circumferential direction of the roller 3 at a regular interval. Furthermore, a width W of each of the grooves is not particularly limited and is able to be set to, for example, 1 μm or more and 1000 μm or less.

In the case of such a configuration, the surface roughness Rz is able to have an appropriate value by appropriately setting the width W of the groove 33, a pitch of the grooves 33, or the like.

Note that the roller 3 is not limited to having the aforementioned configuration and may have, for example, an embossed configuration.

Next, the powder-discharging-amount adjusting section 4 will be described.

As illustrated in FIG. 1, the powder-discharging-amount adjusting section 4 includes a pressing member 41 and an urging member 42 and is a member that adjusts the discharging amount by scraping aggregations of the powder 100 attached to the outer peripheral surface of the roller 3 and separating the aggregations from the roller 3.

The pressing member 41 is formed of an elastic porous body. Moreover, the pressing member 41 has an elongated shape extending in the longitudinal direction of the roller 3, that is, along the central axis O. The pressing member 41 is in contact with a portion of the outer peripheral surface of the roller 3 in the circumferential direction. Moreover, the portion in contact with the pressing member 41 extends in the longitudinal direction of the roller 3. That is, the whole region of the roller 3 in the longitudinal direction is to be in contact with the pressing member 41. As a result, the powder 100 in the whole region of the roller 3 extending along the central axis O is scraped.

The pressing member 41 is elastic and is thus able to deform in accordance with the curved shape of the outer peripheral surface of the roller 3 and stably scrape the powder 100 regardless of the particle diameter of the powder 100. Moreover, it is possible to prevent an excessive load from being applied to the roller 3 pressed by the pressing member 41, and the device is able to be stably driven.

The elastic modulus of the pressing member 41 is not particularly limited and is desirably 0.0002 GPa or more and 0.5 GPa or less and more desirably 0.001 GPa or more and 0.02 GPa or less. Accordingly, the pressing member 41 is able to deform in accordance with the curved shape of the outer peripheral surface of the roller 3, which contributes to quantitative supply of the powder 100.

Since the pressing member 41 is formed of a porous body, fine irregularities are included in the surface thereof. The pressing member 41 is thus able to scrape the powder 100 more reliably. Furthermore, the pressing member 41 is able to scrape the powder 100 by entering into a gap between the irregularities of the surface of the roller 3. This results in contribution to quantitative supply of the powder 100 and results in efficient supply of the powder 100.

The pressing member 41 may have a closed cell structure as illustrated in FIG. 4 or may have an open cell structure and desirably has the closed cell structure. This makes it possible to prevent or inhibit the powder 100 from entering into the pressing member 41 and remaining therein. Accordingly, it is possible to prevent or suppress a change in the elastic modulus of the pressing member 41 due to continuous use. That is, it is possible to sufficiently maintain the elasticity of the pressing member 41 regardless of a use period.

Whether the pressing member 41 has the closed cell structure or the open cell structure is able to be selected by adjusting conditions, such as the amount of a forming agent contained in the constituent material when the pressing member 41 is manufactured and a processing temperature when the pressing member 41 is manufactured. Moreover, whether the pressing member 41 has the closed cell structure or the open cell structure is able to be checked by confirming a water absorption ratio when the pressing member 41 is soaked in water. Since the pressing member 41 having the closed cell structure holds substantially no water, the weight of the pressing member 41 hardly changes even when the pressing member 41 is soaked in water.

A porosity of the pressing member 41 is not particularly limited and is desirably 10% or more and 95% or less and more desirably 30% or more and 90% or less. Accordingly, the surface roughness of the pressing member 41 is able to have a value suitable for scraping the powder 100, and the elastic modulus of the pressing member 41 is able to be easily set within the aforementioned numerical ranges.

An average cell size is not particularly limited and is desirably 10 μm or more and 1000 μm or less and more desirably 100 μm or more and 800 μm or less, for example. This makes it possible to easily reproduce the closed cell structure.

Moreover, the pressing member 41 is pressed against a portion of the outer peripheral surface of the roller 3, which is located below the central axis O of the roller 3. Accordingly, the pressing member 41 is able to have a configuration of scraping the powder 100 at a portion of the roller 3 exposed outside. Thus, it is possible to enhance quantitative supply of the powder 100 more reliably.

Note that the pressing member 41 may be configured to be pressed against a portion of the outer peripheral surface of the roller 3, which is located at the same height as the central axis O of the roller 3.

Moreover, the pressing member 41 is pressed against a portion of the outer peripheral surface of the roller 3, which is exposed outside the storage container 21. This makes it easy to control a position at which the powder 100 drops compared with a case in which the pressing member 41 is pressed against a portion of the outer peripheral surface of the roller 3, which is in the storage container 21 or which is in a boundary section of the interior and the exterior of the storage container 21.

Furthermore, the pressing member 41 is pressed against a portion of the outer peripheral surface of the roller 3, which is exposed outside the storage container 21 and located on the rear side in the rotational direction of the roller 3. Accordingly, upon the outer peripheral surface of the roller 3 being exposed, the pressing member 41 immediately scrapes the powder 100. This makes it possible to prevent or suppress a deterioration in quantitativeness due to the powder 100 unexpectedly peeling off from the roller 3 while the roller 3 rotates.

A constituent material of such a pressing member 41 is not particularly limited, and the pressing member 41 may be formed of, for example, resin-based sponge, such as cellulose sponge, polyvinyl alcohol sponge, urethane foam, ethylene-vinyl acetate copolymer sponge, and melamine foam, and polyethylene foam, or rubber-based sponge, such as natural rubber sponge, chloroprene rubber sponge, ethylene-propylene rubber sponge, and butadiene-acrylonitrile rubber sponge.

As illustrated in FIG. 1, the urging member 42 is formed of an elongated plate-like member and disposed on an extension line of the side wall 212. Accordingly, the pressing member 41 disposed at the lower end of the urging member 42 is able to be pressed against the roller 3.

Note that the urging member 42 may be omitted. In this case, the pressing member 41 is fixed to a portion of the side wall 212, which corresponds to an edge of the discharge port 23. Also in this case, the pressing member 41 is able to be pressed against the roller 3 with an elastic force of the pressing member 41. Moreover, the urging member 42 may be a leaf spring.

In this manner, the powder-discharging-amount adjusting section 4 includes the urging member 42 that urges the pressing member 41 toward the outer peripheral surface of the roller 3. With this, the pressing member 41 is able to be pressed against the roller 3. Accordingly, it is possible to achieve quantitative discharge of the powder 100 more reliably.

As described above, the powder supplying device 1 includes: the storage section 2 including the storage container 21 that includes the interior space 210 in which the powder 100 is stored and the discharge port 23 through which the powder 100 is discharged from the interior space 210 to the exterior; the roller 3 the outer peripheral surface of which is rough and which is provided across the interior space 210 and the exterior and configured to rotate in the discharge port 23; and the powder-discharging-amount adjusting section 4 that includes the pressing member 41 which is formed of an elastic porous body and which is pressed against the outer peripheral surface of the roller 3. Since the pressing member 41 is elastic, the pressing member 41 is able to deform in accordance with the curved shape of the outer peripheral surface of the roller 3 and is able to stably scrape the powder 100 regardless of the particle diameter of the powder 100. Furthermore, since the pressing member 41 is formed of the porous body, fine irregularities of the surface enable the powder 100 to be scraped more reliably. Furthermore, the pressing member 41 is able to scrape the powder 100 by entering into a gap between the irregularities of the surface of the roller 3, which contributes to quantitative supply of the powder 100 and efficient supply of the powder 100.

Although the powder supplying device of the disclosure has been described above with reference to the illustrated embodiment, the disclosure is not limited to the embodiment, and sections and processes constituting the powder supplying device are able to be replaced with ones having any configuration capable of exerting a similar function.

What is claimed is:

1. A powder supplying device comprising:
a storage section including a storage container that includes an interior space in which a powder is stored and a discharge port through which the powder is discharged from the interior space to an exterior;
a roller an outer peripheral surface of which is rough and which is provided across the interior space and the exterior and configured to rotate in the discharge port; and
a powder-discharging-amount adjusting section that includes a pressing member which is formed of an elastic porous body and which is pressed against the outer peripheral surface of the roller.

2. The powder supplying device according to claim 1, wherein
the pressing member has a closed cell structure.

3. The powder supplying device according to claim 1, wherein
surface roughness (Rz) of the outer peripheral surface of the roller is 1 or more and 1000 or less.

4. The powder supplying device according to claim 1, wherein
an average particle diameter (D) of the powder is 150 μm or more.

5. The powder supplying device according to claim 1, wherein
the pressing member is pressed against a portion of the outer peripheral surface of the roller, the portion being located below a central axis of the roller.

6. The powder supplying device according to claim 1, wherein
the powder-discharging-amount adjusting section includes an urging member that urges the pressing member toward the outer peripheral surface of the roller.
